(19) United States
(12) Patent Application Publication
(10) Pub. No.: US 2020/0243092 A1
(43) Pub. Date: Jul. 30, 2020

(54) INFORMATION PROCESSING DEVICE, INFORMATION PROCESSING SYSTEM, AND COMPUTER PROGRAM PRODUCT

(71) Applicant: FUJITSU CLIENT COMPUTING LIMITED, Kanagawa (JP)

(72) Inventor: Yasushi Yabuuchi, Kawasaki (JP)

(73) Assignee: FUJITSU CLIENT COMPUTING LIMITED, Kanagawa (JP)

(21) Appl. No.: 16/720,232

(22) Filed: Dec. 19, 2019

(30) Foreign Application Priority Data
Jan. 25, 2019 (JP) 2019-011654

(51) Int. Cl. G10L 15/26; G10L 15/187; G06F 40/242; G10L 17/00; G10L 17/04; G10L 15/02

(52) U.S. Cl. CPC G10L 15/26; G10L 15/187; G06F 40/242; G10L 2015/025; G10L 17/04; G10L 15/02; G10L 17/005

(57) ABSTRACT

An information processing device includes an acquirer and a registration unit. The acquirer acquires one or more morphemes constituting text data included in a manuscript in a predetermined scene. The registration unit converts a syllable of each of the one or more morphemes into a phoneme and registers the morpheme, the syllable, and the phoneme in a pronunciation dictionary.

### CROSS-REFERENCE TO RELATED APPLICATIONS

This application is based upon and claims the benefit of priority from Japanese Patent Application No. 2019-011654, filed Jan. 25, 2019, the entire contents of which are incorporated herein by reference.

### FIELD

The present disclosure relates generally to an information processing device, an information processing system, and a computer program product.

### BACKGROUND

Widely known are techniques for recognizing speech and converting it into a character string. There has been developed a technique for converting speech into a character string by dividing the speech into phonemes using an acoustic model and analyzing the phonemes using a dictionary.

In a scene where speech recognition is performed, technical terms or coined words unique to the scene may possibly be used. However, in the conventional technique, it is difficult to perform speech recognition on the technical term or coined word which is not registered in the dictionary. As a result, erroneous recognition may possibly occur.

### SUMMARY

According to an aspect of the present disclosure, an information processing device includes an acquirer and a registration unit. The acquirer acquires one or more morphemes constituting text data included in a manuscript which is used in a predetermined scene. The registration unit converts a syllable of each of the one or more morphemes into a phoneme and registers the morpheme, the syllable, and the phoneme in a pronunciation dictionary.

### BRIEF DESCRIPTION OF THE DRAWINGS

FIG. 1 is a schematic drawing illustrating an example of an information processing system according to an embodiment;

FIG. 2 is a functional block diagram of an information processing device and a terminal device according to the embodiment;

FIG. 3 is a drawing schematically illustrating an example of a data configuration of a pronunciation dictionary according to the embodiment;

FIG. 4 is a drawing schematically illustrating an example of a data configuration of a language model according to the embodiment;

FIG. 5 is a drawing schematically illustrating an example of a data configuration of a recognition result data base (DB) according to the embodiment;

FIG. 6 is a drawing schematically illustrating an example of an output screen according to the embodiment;

FIG. 7 is a sequence diagram illustrating an example of a procedure of registration to the pronunciation dictionary and updating of the language model according to the embodiment;

FIG. 8 is a sequence diagram of an example of a procedure of speech recognition performed by the information processing system according to the embodiment; and

FIG. 9 a drawing illustrating an example of a hardware configuration of the information processing device and the terminal device.

### DETAILED DESCRIPTION

Exemplary embodiments according to the present disclosure are described below. The configurations according to the embodiments described below and the operations and advantageous effects provided by the configurations are given by way of example only. The embodiments described below are not intended to limit the technical features disclosed herein.

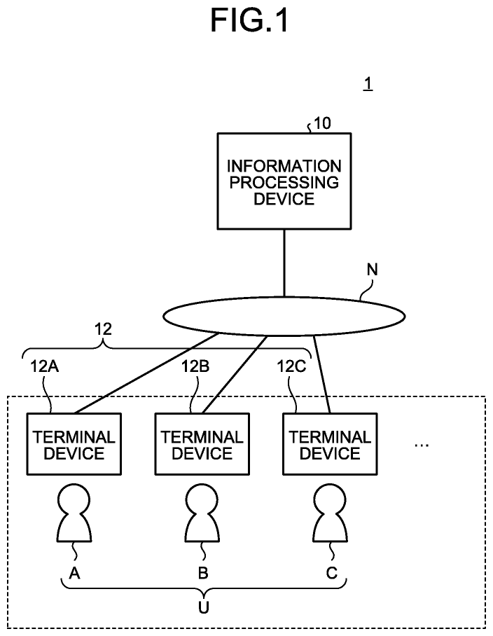

FIG. 1 is a schematic drawing illustrating an example of an information processing system 1 according to an embodiment.

The information processing system 1 includes an information processing device 10 and terminal devices 12. The information processing device 10 and the terminal devices 12 are connected to communicate with each other via a network N.

The network N is a known communication network. The network N includes, but are not limited to, the Internet, a mobile phone network, etc. The network N is formed by use of cables, transceivers, routers, switches, wireless LAN access points, or wireless LAN transmitters/receivers, for example.

The terminal device 12 is a terminal operated by an operator U. The operator U is an example of a user of the terminal device 12. The terminal device 12 includes, but is not limited to, a personal computer, a tablet terminal, etc. The terminal device 12 collects speech of the operator U who operates the terminal device 12, and transmits speech data to the information processing device 10.

In the present embodiment, the information processing system 1 includes a plurality of terminal devices 12 (terminal devices 12A to 12C). The plurality of terminal devices 12 are operated by operators U, respectively. The terminal device 12A is operated by an operator U “A”, the terminal device 12B is operated by an operator U “B”, and the terminal device 12C is operated by an operator U “C”, for example.

The information processing device 10 performs speech recognition on speech data received from the terminal device 12 and outputs a character string (described later in detail). In the present embodiment, the character string means data representing a series of characters. The information processing device 10 may be a personal computer, for example.

FIG. 1 illustrates, by way of example, the information processing system 1 having a configuration in which one information processing device 10 and three terminal devices 12 are included. The number of information processing devices 10 included in the information processing system 1 is not limited to one. The information processing system 1 may include two or more information processing devices 10. Furthermore, the information processing system 1 may include one, two, or four or more terminal devices 12.

The information processing system 1 according to the present embodiment is used for a scene where one or more operators U speak.

With respect to the scene, it is assumed that one or more operators U speak according to their manuscripts in the scene. Examples of the scene include, but are not limited to, a meeting, a lecture, a conference, an interview, a speech, etc. The present embodiment is described in an exemplary case where the scene is a meeting. Users who speak in the scene are not limited to the operators U. Users other than the operators U of the terminal devices 12 may speak, for example.

The manuscript may be a document used in the scene such as a meeting. The manuscript includes a text (characters). The manuscript is in a form of at least one of a medium, such as papers and a board, and digitized manuscript data. The manuscript is created by the operator U, for example (described later in detail).

In the scene, one or more operators U read the text on the manuscript and give utterance of a speech to proceed the meeting, for example. The speech data corresponding to the utterance given in the scene are collected by the terminal devices 12 and subjected to speech recognition by the information processing device 10 (described later in detail).

In the present embodiment, before the speech is given based on the manuscript in a predetermined scene, the information processing device 10 performs registration to a pronunciation dictionary used for speech recognition and updating of a language model, for example (described later in detail). After then, in the scene such as a meeting, the information processing device 10 performs speech recognition on the speech given by the one or more operators U based on the manuscripts which are used in the meeting. The present embodiment will be described in this situation.

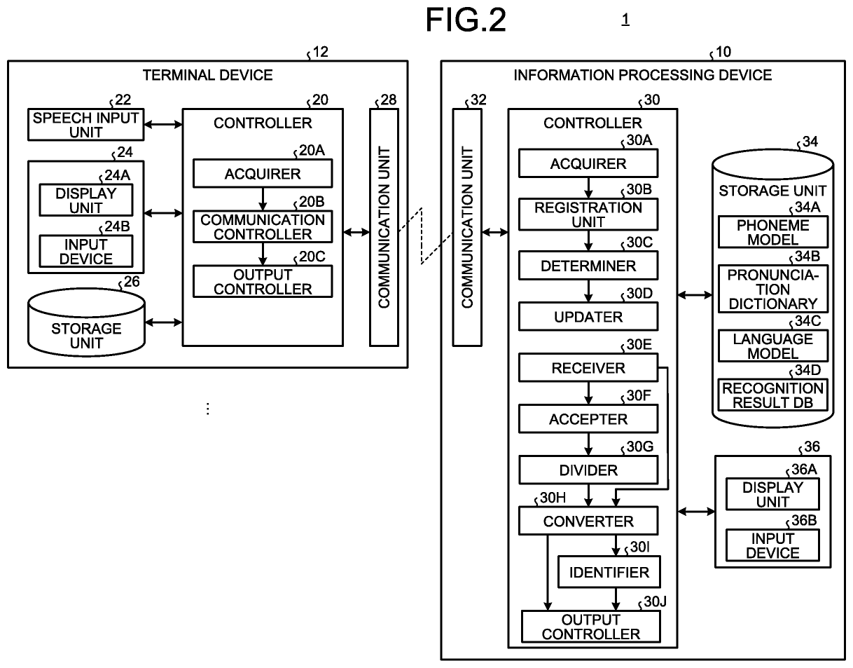

The following describes a functional configuration of the information processing device 10 and the terminal device 12. FIG. 2 is an exemplary functional block diagram of the information processing device 10 and the terminal device 12.

The terminal device 12 is described first. The terminal device 12 includes a controller 20, a speech input unit 22, a user interface (UI) 24, a storage unit 26, and a communication unit 28. The speech input unit 22, the UI 24, the storage unit 26, and the communication unit 28 are connected to the controller 20 such that they can transmit and receive data or signals to and from the controller 20.

The speech input unit 22 collects speech of the operator U and outputs speech data to the controller 20. The speech input unit 22 may include a microphone.

The UI 24 has an input device 24B for performing a function of receiving operating instructions from the operator U and a display unit 24A for performing a function of displaying an image. The input device 24B may include a keyboard or a mouse, for example. The display unit 24A may include a liquid crystal display or an organic electroluminescence (EL) display, for example. The UI 24 may be a touch panel having an input function and a display function integrally.

The storage unit 26 stores therein various kinds of information. The storage unit 26 is a known storage medium, such as a hard disk drive (HDD). The storage unit 26 may be provided to an external device connected via the network N.

The communication unit 28 is a communication interface to communicate with the information processing device 10.

The controller 20 includes an acquirer 20A, a communication controller 20B, and an output controller 20C.

Each of the components described above may be realized by one or more processors, for example. Each of the components may be provided by causing a processor, such as a central processing unit (CPU), to execute a computer program, that is, implemented by software. Alternatively, each of the components may be provided by a processor, such as a dedicated integrated circuit (IC), that is, implemented by hardware. Still alternatively, each of the components may be implemented by a combination of software and hardware. If a plurality of processors are used, each of the processors may implement each one of the components or two or more of the components.

The acquirer 20A acquires speech data from the speech input unit 22. The acquirer 20A also acquires text data included in the manuscript used in the predetermined scene.

The operator U operates the input device 24B of the terminal device 12, for example, to create manuscript data to be used in a meeting. In response to reception of an input operation performed by the operator U through the input device 24B, the controller 20 of the terminal device 12 creates manuscript data using application software or the like previously installed in the controller 20 and stores the manuscript data in the storage unit 26. The application software may be known application software for creating documents. While the known application software for creating documents may be software programs included in Microsoft Office (word processing software (Word), spreadsheet software (Excel), and presentation software (PowerPoint)), for example, the present embodiment is not limited thereto.

The controller 20 may acquire the manuscript data by reading characters written on a medium by use of a known scanner and store the manuscript data in the storage unit 26. Alternatively, the controller 20 may acquire the manuscript data by reading the manuscript data from an external device or the like via the network N and store the manuscript data in the storage unit 26.

The acquirer 20A reads the manuscript data from the storage unit 26. The acquirer 20A acquires text data from the manuscript data by extracting character (text) data from the manuscript data using a known method.

Let us assume a case where the manuscript data is acquired by reading it from a medium by a scanner, for example. In this case, the acquirer 20A acquires the text data by analyzing the manuscript data by use of a known character recognition technique. Alternatively, let us assume a case where the manuscript data is created using the known application software previously installed in the controller 20 to create documents, for example. In this case, the acquirer 20A acquires the text data by extracting text data from the manuscript data by use of a known method. To extract the text data, the acquirer 20A, for example, uses a known text extraction software program (e.g., xdoc2txt) or a preview function provided to known application software, such as Outlook.

The communication controller 20B controls communications with the information processing device 10.

When the acquirer 20A acquires the text data included in the manuscript, the communication controller 20B transmits the text data to the information processing device 10.

When the acquirer 20A acquires the speech data, the communication controller 20B transmits the speech data and terminal identification information of the terminal device 12 to the information processing device 10 via the communication unit 28.

The terminal identification information is information for identifying the terminal device 12. The present embodiment will be explained in a case where identification information of the operator U who operates the terminal device 12 is used for the terminal identification information, for example. The identification information of the operator U may be a login account used to log in to the terminal device 12, for example.

The output controller 20C receives output information including a speech recognition result from the information processing device 10 via the communication unit 28. The output controller 20C outputs the received output information to the display unit 24A. The output information will be described later in detail.

The following describes the information processing device 10. The information processing device 10 includes a controller 30, a communication unit 32, a storage unit 34, and a user interface (UI) 36. The communication unit 32, the storage unit 34, and the UI 36 are connected to the controller 30 such that they can transmit and receive data or signals to and from the controller 30.

The communication unit 32 is a communication interface to communicate with the terminal device 12. The UI 36 has an input device 36B for performing an input function of receiving operating instructions from a user and a display unit for performing a display function of displaying an image. The UI 36 may be a touch panel having the input function and the display function integrally.

The storage unit 34 stores therein various kinds of information. The storage unit 34 is a known storage medium, such as an HDD. The storage unit 34 may be provided to an external device connected via the network N.

The storage unit 34 according to the present embodiment stores therein a phoneme model 34A, a pronunciation dictionary 34B, a language model 34C, and a recognition result data base (DB) 34D. The information stored in the storage unit 34 will be described later in detail.

The controller 30 includes an acquirer 30A, a registration unit 30B, a determiner 30C, an updater 30D, a receiver 30E, an accepter 30F, a divider 30G, a converter 30H, a identifier 30I, and an output controller 30J.

Each of the components described above may be implemented by one or more processors, for example. Each of the components may be provided by causing a processor, such as a central processing unit (CPU), to execute a computer program, that is, implemented by software. Alternatively, each of the components may be provided by a processor, such as a dedicated IC, that is, implemented by hardware. Still alternatively, each of the components may be implemented by a combination of software and hardware. If a plurality of processors are used, each of the processors may implement each one of the components or two or more of the components.

The acquirer 30A, the registration unit 30B, the determiner 30C, and the updater 30D are described first. The acquirer 30A, the registration unit 30B, the determiner 30C, and the updater 30D are functional units for performing registration to the pronunciation dictionary 34B used in speech recognition and for performing updating of the language model 34C. The registration and the updating are carried out before the speech is given based on the manuscript in the scene such as a meeting.

The acquirer 30A acquires one or more morphemes that constitute the text data included in the manuscript which is used in the predetermined scene.

The acquirer 30A according to the present embodiment receives the text data included in the manuscript from the terminal device 12 via the communication unit 32. The acquirer 30A segments the received text data into one or more morphemes by analyzing the received text data using a known morphological analysis method. By performing this processing, the acquirer 30A extracts and acquires one or more morphemes constituting the text data included in the manuscript.

A morpheme is the smallest unit that is a meaningful expression element, and the morpheme is composed of one or more phonemes. The morpheme according to the present embodiment may include at least one of a free morpheme and a bound morpheme. The free morpheme functions independently as a word, whereas the bound morpheme is used together with other morphemes. Alternatively, instead of using the morphemes, the information processing system 1 may use a word composed of one or more morphemes.

The acquirer 30A may acquire the manuscript data from the terminal device 12 or an external device, for example. In this case, the acquirer 30A may acquire one or more morphemes that constitute the text data in the manuscript data by analyzing the acquired manuscript data using a known method. The following example describes a case where the text data included in the manuscript is composed of a plurality of morphemes.

The registration unit 30B converts syllables of the one or more morphemes acquired by the acquirer 30A into phonemes and registers the phonemes in the pronunciation dictionary 34B.

A syllable indicates a way of reading of a morpheme and includes a vowel, or a vowel and a consonant. The registration unit 30B analyzes a syllable of a morpheme using the phoneme model 34A and converts the analyzed syllable into a phoneme or phonemes. The registration unit 30B associates the morpheme, the syllable, and the phoneme with one another and registers the morpheme, the syllable, and the phoneme in the pronunciation dictionary 34B.

The phoneme model 34A is a model for identifying the phoneme and the syllable (way of reading) that constitute speech. The phoneme model 34A may be referred to as an acoustic model. The phoneme model 34A is modeled for each phoneme. A known phoneme model or acoustic model may be used for the phoneme model 34A.

The pronunciation dictionary 34B is used to associate the morphemes registered in the language model 34C, which will be described later, with the phonemes indicated by the phoneme model 34A.

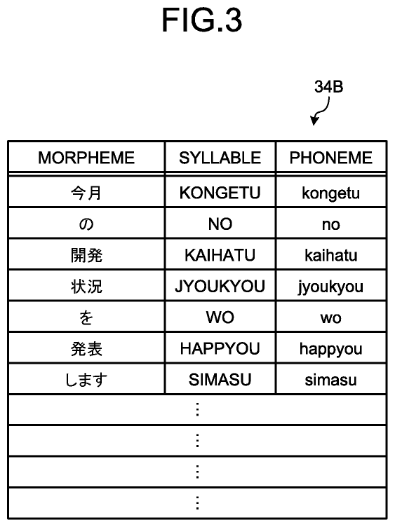

FIG. 3 is a drawing schematically illustrating an example of a data configuration of the pronunciation dictionary 34B. The pronunciation dictionary 34B associates the morpheme, the syllable, and the phoneme with one another.

While one syllable is associated with one morpheme in FIG. 3, for example, a plurality of syllables (ways of reading) may possibly be present for one morpheme (or word). A morpheme in Japanese shown below (which means “genius” in English), for example, has a plurality of kinds of syllables (ways of reading), such as “TENSAI”, “TENZAI”, “TENZAE”, “SORASAI”, “SORAZAI”, “SORAZAE”, “AMESAI”, “AMEZAI”, “AMEZAE”, “AMASAI”, “AMAZAI”, and “AMAZAE”.

[symbol]

Consequently, the registration unit 30B may register a plurality of kinds of syllables in a manner associated with one morpheme in the pronunciation dictionary 34B. In this case, for one morpheme, a plurality of kinds of syllables and a plurality of phonemes (or phoneme strings) corresponding to the respective kinds of syllables are associated with each other, and the pronunciation dictionary 34B stores therein the plurality of kinds of syllables and the plurality of phonemes.

Referring back to FIG. 2, the registration unit 30B registers, for the respective morphemes included in the text data acquired by the acquirer 30A, the syllables and the phonemes in the pronunciation dictionary 34B. As a result, the syllables and the phonemes are associated with each of all the morphemes included in the text data acquired by the acquirer 30A and registered in the pronunciation dictionary 34B.

In other words, in advance of a scene such as a meeting, each of the morphemes included in the text data of the manuscript to be used in the scene are associated with the syllables and the phonemes, and the morpheme and the corresponding syllables and phonemes are registered in the pronunciation dictionary 34B.

For each of the morphemes included in the text data acquired by the acquirer 30A, the determiner 30C determines an appearance frequency at which the morpheme appears in the text data.

The appearance frequency is the ratio of the number of each of the morphemes to the total number of morphemes included in the text data. The determiner 30C determines the appearance frequency using a known analysis method.

The updater 30D updates an appearance probability of a word string included in the language model 34C in a case where the word string includes a morpheme used to determine an appearance frequency. The updater 30D updates the appearance probability of the word string based on the difference between the appearance frequency and a reference frequency. In other words, the morpheme used to determine the appearance frequency is the morpheme having the appearance frequency. The language model 34C is a model used to evaluate whether a character string or a word string is appropriate for a certain language (e.g., Japanese).

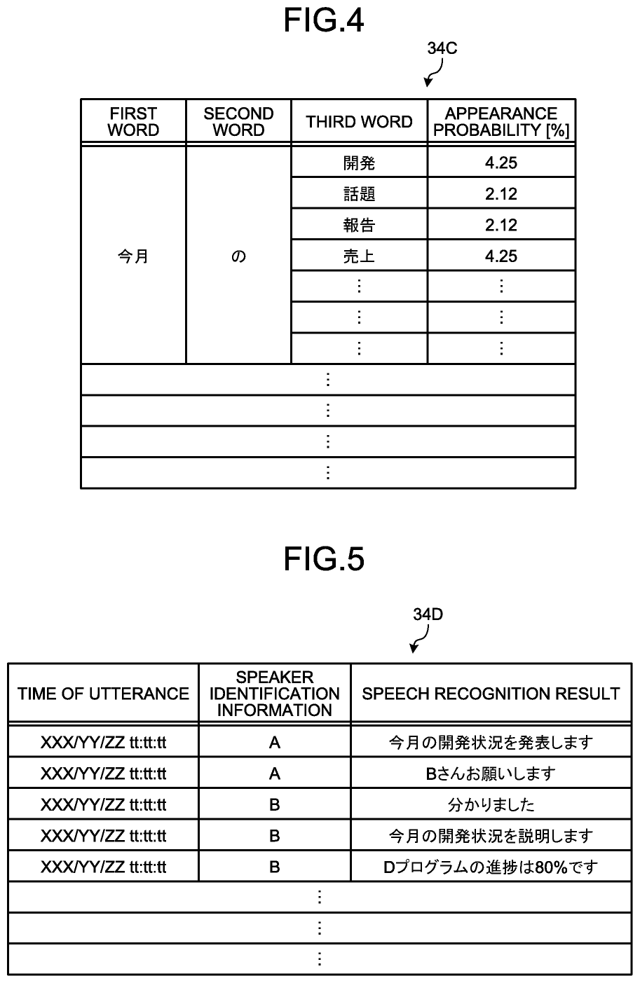

FIG. 4 is a drawing schematically illustrating an example of a data configuration of the language model 34C. The language model 34C associates a plurality of kinds of word strings with appearance probabilities of the respective kinds of word strings at which the word strings are expected to appear in the text data.

The word string is arranged by combining one or a plurality of morphemes. If one morpheme serves as one word, the word string is arranged by combining a plurality of words. A plurality of kinds of word strings are different from each other in at least one of the kinds of included morphemes, the number of included morphemes, and the order of the arrangement of the morphemes.

FIG. 4 illustrates the word strings obtained by arranging three morphemes of a first word, a second word, and a third word, for example. The number of morphemes constituting each of the word strings which are registered in the language model 34C may be one, two, or four or more, and the word string is not limited to an arrangement of three morphemes.

The updater 30D receives a plurality of morphemes included in the text data and the appearance frequencies of the respective morphemes from the determiner 30C. The updater 30D calculates the differences of the respective received appearance frequencies from the reference frequency.

The reference frequency may be predetermined. The reference frequency may be determined in advance based on an average of the appearance frequencies of the respective morphemes included in one manuscript, for example. The manuscript used to calculate the average may be a manuscript used in a certain scene or a manuscript created in advance as a manuscript used in a typical scene.

For a word string which includes a morpheme used to determine an appearance frequency, the updater 30D updates the appearance probability of the word string in the language model 34C to a value which is larger than a reference appearance probability such that the larger a difference between the reference frequency and the appearance frequency of the morpheme which is larger than the reference frequency, the larger a difference between the value and the reference appearance probability.

The reference appearance probability may be predetermined. The reference appearance probability may be the same value as the reference frequency, for example.

On the other hand, for a word string which includes a morpheme used to determine an appearance frequency, the updater 30D updates the appearance probability of the word string in the language model 34C to a value which is smaller than the reference appearance probability such that the larger a difference between the reference frequency and the appearance frequency of the morpheme which is smaller than the reference frequency, the larger a difference between the value and the reference appearance probability.

Specifically, for each of the plurality of morphemes included in the text data acquired by the acquirer 30A, as the morpheme has a higher appearance frequency in the text data, the updater 30D updates the appearance probability of a word string including the morpheme to a larger value. On the other hand, for each of the plurality of morphemes included in the text data acquired by the acquirer 30A, as the morpheme has a lower appearance frequency in the text data, the updater 30D updates the appearance probability of the word string including the morpheme to a smaller value.

As described above, for each of a plurality of kinds of word strings registered in the language model 34C, if the word string includes a morpheme having a higher appearance frequency in the certain manuscript, the updater 30D updates the appearance probability corresponding to the word spring to a higher appearance probability.

Consequently, the updater 30D can update the language model 34C such that the word strings which are included in the manuscript used in the scene (e.g. a meeting) have a higher appearance probability. In other words, the updater 30D can update the language model 34C such that the speech data can be converted, in speech recognition, preferentially to a character string including a unique morpheme used in the scene.

In each scene such as a meeting, the acquirer 30A, the registration unit 30B, the determiner 30C, and the updater 30D perform the above-described processing on the text data of one or a plurality of manuscripts used in the scene.

The acquirer 30A, for example, acquires scene identification information identifying the scene and the text data of the manuscript from the terminal device 12. The scene identification information is information for uniquely identifying a scene, such as a meeting and a lecture, and is provided by the terminal device 12 that creates the manuscript.

In each scene such as a meeting, the acquirer 30A, the registration unit 30B, the determiner 30C, and the updater 30D can perform registration to the pronunciation dictionary 34B and updating of the language model 34C using the text data of one or a plurality of manuscripts used in the scene. In other words, in each scene, the information processing device 10 can perform registration to the pronunciation dictionary 34B and updating of the language model 34C based on the manuscript used in the scene.

For a word string composed by morphemes other than the morphemes included in the text data of one or more manuscripts used in the scene, it is preferable that the updater 30D updates the appearance probability of the word string to the reference appearance probability in the language model 34C. By performing this processing, in speech recognition for a scene held subsequently to the present registration and updating, the updater 30D can update the language model 34C such that morphemes used in the subsequent scene have higher priorities. Thus, the updater 30D can increase the accuracy in speech recognition in the subsequent scene.

The following describes the receiver 30E, the accepter 30F, the divider 30G, the converter 30H, the identifier 30I, and the output controller 30J.

The receiver 30E, the accepter 30F, the divider 30G, the converter 30H, the identifier 30I, and the output controller 30J are functional units that perform speech recognition on the speech given by one or more operators U. The speech recognition is performed in the scene such as a meeting.

The receiver 30E receives from the terminal device 12 the speech data and the terminal identification information of the terminal device 12 that collects the speech for the speech data. The receiver 30E may receive at least the speech data.

In the scene such as a meeting, the utterances of speeches given by a plurality of operators U are collected by the speech input units 22 of the terminal devices 12 that are operated by the respective operators U. The terminal devices 12 transmit the collected speech data and the terminal identification information of the respective terminal devices 12 to the information processing device 10. The information processing device 10 receives the speech data and the terminal identification information from the terminal devices 12.

The divider 30G divides the speech data received by the receiver 30E into one or more phonemes using the phoneme model 34A. The divider 30G divides the speech data into the phonemes using the phoneme model 34A by a known method. The divider 30G, for example, divides the speech data into one or more phonemes by repeatedly analyzing the characteristics of the speech data and deriving the phoneme closest to the characteristics from the phoneme model 34A.

The converter 30H analyzes one or more phonemes resulting from the division of the speech data by the divider 30G using the pronunciation dictionary 34B and the language model 34C, and converts the speech data into a character string composed of characters corresponding to the one or a plurality of morphemes.

The converter 30H, for example, reads, from the pronunciation dictionary 34B, a morpheme corresponding to a series of the one or more phonemes resulting from the division of the speech data by the divider 30G. The series of one or more phonemes is an arrangement in which phonemes are arranged in time series in order of appearance in the speech data. The converter 30H converts the speech data into a character string for every word string by adopting a word string having the highest appearance probability among a set of the word strings which are obtained by arranging the read morphemes in time series.

By repeating the processing described above, the converter 30H performs speech recognition on the speech data and converts the speech data into the character string.

The identifier 30I identifies the operator U of the terminal device 12 identified by the terminal identification information as the speaker of the speech data received by the receiver 30E. The identifier 30I, for example, identifies the operator U as the speaker using the terminal identification information as the identification information of the operator U. The identifier 30I may associates the identification information of the operator U with the terminal identification information and store in advance the terminal identification information and the identification information of the operator U in the storage unit 34. In this case, the identifier 30I identifies the speaker of the speech data by reading, from the storage unit 34, the identification information of the operator U corresponding to the received terminal identification information.

The output controller 30J associates the result of the speech recognition on the speech data by the converter 30H with the result of identifying the speaker of the speech data by the identifier 30I, and stores the result of the speech recognition and the result of identifying the speaker in the recognition result DB 34D.

FIG. 5 is a drawing schematically illustrating an example of a data configuration of the recognition result DB 34D. The recognition result DB 34D, for example, associates a time of utterance, identification information of a speaker, and a speech recognition result with one another.

The output controller 30J registers the time of reception of the speech data as the time of utterance in the recognition result DB 34D. The output controller 30J may obtain, from the terminal device 12 that collects the speech, the speech data and the time of collection of the speech for the speech data. In this case, the output controller 30J uses the time of collection of the speech as the time of utterance for the speech data.

The output controller 30J registers associates the result of speech recognition by the converter 30H with the speaker identification information of the speaker of the speech data identified by the identifier 30I, and registers the result of speech recognition and the speaker identification information in the recognition result DB 34D. The terminal identification information may be used as the speaker identification information.

The speech recognition result is a character string (that is, data representing the character string) obtained by converting the speech data by the converter 30H.

Referring back to FIG. 2, the output controller 30J outputs the output information including the speech recognition result to at least one of a display unit 36A and the terminal device 12.

The output information includes at least the speech recognition result. The output information may further include the identification information of the identified speaker and the time of utterance of the speech. The output information according to the present embodiment includes the speech recognition result, the identification information of the speaker, and the time of utterance of the speech, for example.

The output controller 30J may generate an output image for displaying the character strings corresponding to the speech recognition results of the speech data which are arranged in order of the times of utterances. The output controller 30J may output the output image as the output information to at least one of the terminal device 12 and the display unit 36A.

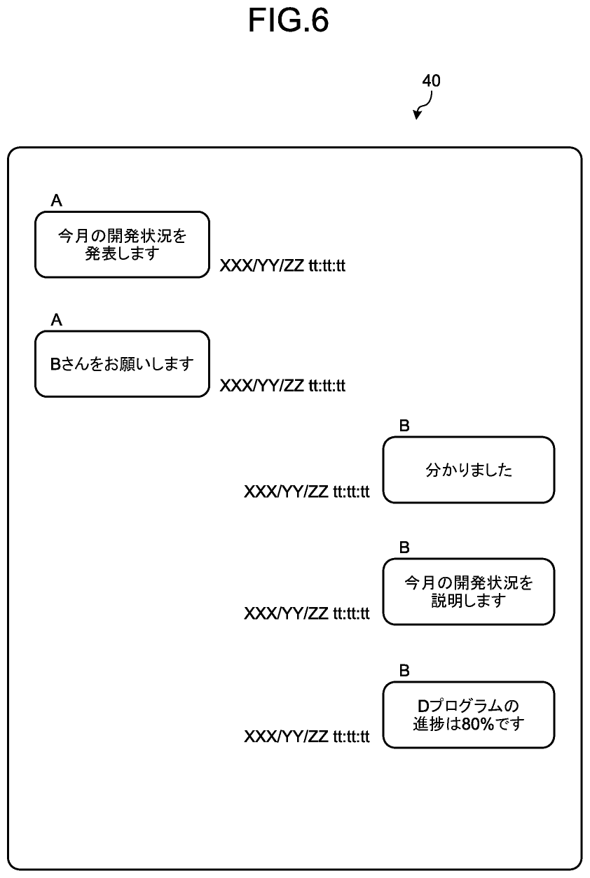

FIG. 6 is a drawing schematically illustrating an example of an output screen 40. The output screen 40 displays the character strings corresponding to the speech recognition results, the times of utterances, and the identification information of the speakers in time series in order of the times of utterances.

The output controller 30J outputs the output screen 40 as the output information to the display unit 36A of the information processing device 10, whereby the display unit 36A displays the output screen 40. The output controller 30J transmits the output information for the output screen 40 to the terminal device 12 via the communication unit 32, whereby the display unit 24A of the terminal device 12 displays the output screen 40.

Thus, according to the embodiment, the operators U participating in the scene such as a meeting can readily check the speech recognition results. In addition, the information processing device 10 can provide information that facilitates creation of minutes based on the speech recognition results.

The appearance frequencies of the morphemes used in a scene are assumed to change depending on the scenes and the times.

To address this, the updater 30D preferably updates, in the language model, the appearance probabilities to the reference appearance probability if a predetermined condition is satisfied.

The predetermined condition may be determined in advance. Examples of the predetermined condition include, but are not limited to, timing at which one scene, such as a meeting, ends, elapse of a predetermined time, correspondence to an updating timing determined in advance, etc.

The updater 30D may reset the appearance probabilities registered in the language model 34C if the predetermined condition is satisfied.

In each of a plurality of scenes, the registration unit 30B and the updater 30D may perform registration to the pronunciation dictionary 34B and updating of the language model 34C based on one or a plurality of manuscripts used in the scene.

The following describes the procedure of information processing performed by the information processing system 1.

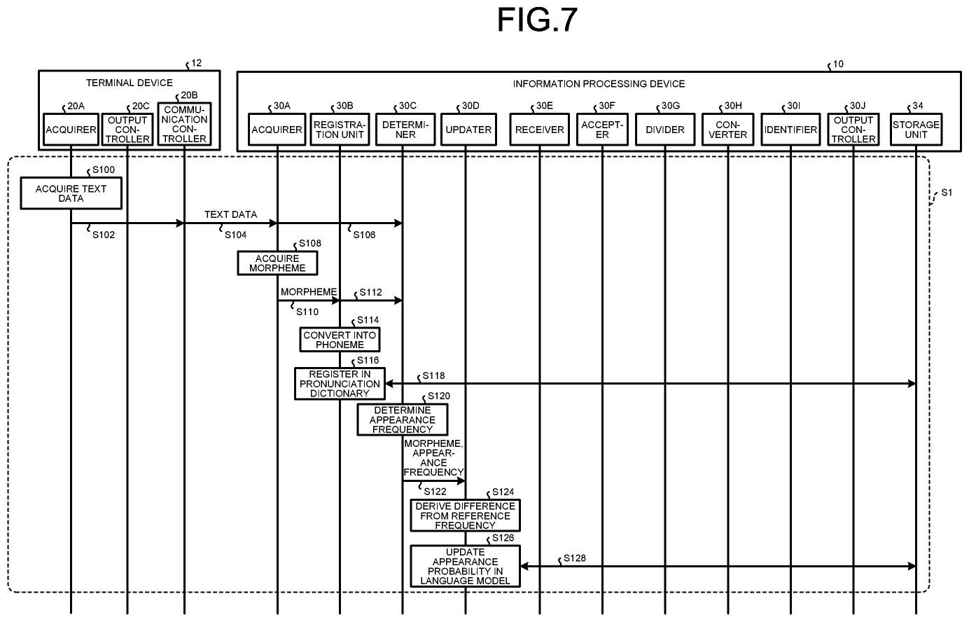

FIG. 7 is a sequence diagram of an example of the procedure of registration to the pronunciation dictionary 34B and updating of the language model 34C.

The acquirer 20A of the terminal device 12 acquires text data included in a manuscript used in a specific scene (Step S100).

The communication controller 20B transmits the text data acquired by the acquirer 20A to the information processing device 10 (Steps S102 and S104).

The acquirer 30A of the information processing device 10 acquires the text data included in the manuscript from the terminal device 12 (Step S104). The acquirer 30A outputs the acquired text data to the determiner 30C (Step S106). The acquirer 30A also acquires a plurality of morphemes by extracting the plurality of morphemes from the acquired text data (Step S108).

The acquirer 30A outputs the extracted morphemes to the registration unit 30B and the determiner 30C (Steps S110 and S112).

The registration unit 30B converts syllables of the morphemes acquired by the acquirer 30A into phonemes (Step S114). For each of the plurality of morphemes included in the text data acquired by the acquirer 30A, the registration unit 30B registers the syllables and the phonemes in the pronunciation dictionary 34B (Steps S116 and S118). As a result, for each of all the morphemes included in the text data acquired by the acquirer 30A, the syllables and the phonemes that correspond to the morpheme are registered in the pronunciation dictionary 34B.

Subsequently, for each of the plurality of morphemes included in the text data acquired by the acquirer 30A, the determiner 30C determines the appearance frequency at which the morpheme appears in the text data (Step S120). The determiner 30C outputs each of the plurality of morphemes and the appearance frequency of the morpheme to the updater 30D (Step S122).

The updater 30D derives, for each of the plurality of morphemes received from the determiner 30C, the difference between the appearance frequency of the morpheme and the reference frequency (Step S124). Then, for each of the plurality of morphemes received from the determiner 30C and for a word string which includes the morpheme used to identify the appearance frequency, the updater 30D updates the appearance probability of the word string in the language model 34C based on the difference between the appearance frequency and the reference frequency (Steps S126 and S128).

The acquirer 30A, the registration unit 30B, the determiner 30C, and the updater 30D perform the registration and updating operations, which are indicated from Step S100 to Step S128 (Step S1), on all the text data of one or a plurality of manuscripts used in the same scene.

As a result, the storage unit 34 stores therein the pronunciation dictionary 34B, which includes the morphemes of coined words and any other terms or words used in a specific scene (e.g. a meeting), and the language model 34C updated for the scene.

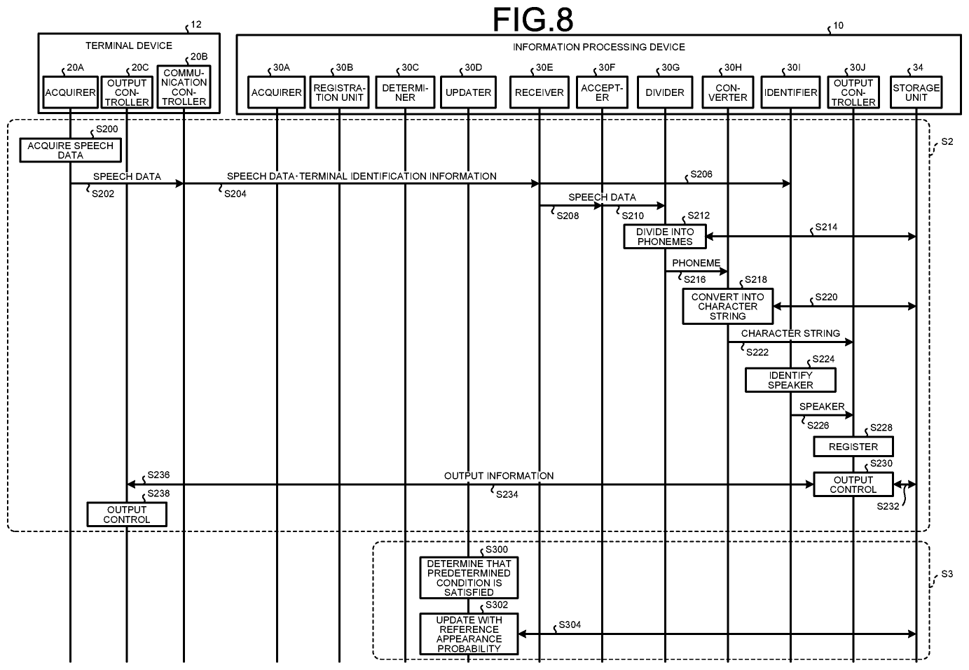

FIG. 8 is a sequence diagram of an example of the procedure of speech recognition performed by the information processing system 1. Let us assume a case where a plurality of operators U participate in a meeting or the like while operating the respective terminal devices 12 assigned thereto, for example.

The acquirer 20A of the terminal device 12 acquires speech data for the utterance of speech given by the operator U of the terminal device 12 (Step S200). The communication controller 20B of the terminal device 12 receives the speech data from the acquirer 20A (Step S202). The communication controller 20B transmits the speech data acquired by the acquirer 20A and the terminal identification information of the terminal device 12 to the information processing device 10 (Step S204).

The receiver 30E of the information processing device 10 receives the speech data and the terminal identification information of the terminal device 12 that collects the speech of the speech data. The receiver 30E outputs the received terminal identification information to the identifier 30I (Step S206). The receiver 30E also outputs the received speech data to the accepter 30F (Step S208). The accepter 30F outputs the received speech data to the divider 30G (Step S210).

The divider 30G divides the received speech data into one or a plurality of phonemes using the phoneme model 34A (Steps S212 and S214). The divider 30G outputs a series of the plurality of phonemes included in the speech data to the converter 30H (Step S216).

The converter 30H analyzes the series of the plurality of phonemes resulting from the division of the speech data by the divider 30G using the pronunciation dictionary 34B and the language model 34C and converts the speech data into a character string composed of a plurality of morphemes (Steps S218 and S220). The converter 30H performs speech recognition on the speech data by converting the series of phonemes included in the speech data into the character string. The converter 30H outputs the character string that is the speech recognition result of the speech data to the output controller 30J (Step S222).

The identifier 30I identifies the operator U of the terminal device 12 which is identified by the terminal identification information received at Step S206 as the speaker of the speech data received by the receiver 30E (Step S224). The identifier 30I outputs information identifying the speaker (e.g., the speaker identification information or the terminal identification information) to the output controller 30J (Step S226).

The output controller 30J associates the result of speech recognition on the speech data by the converter 30H and the result of identifying the speaker of the speech data by the identifier 30I with each other and registers the result of speech recognition and the result of identifying the speaker in the recognition result DB 34D (Step S228).

The output controller 30J outputs output information including the speech recognition result to at least one of the display unit 36A and the terminal device 12 (Steps S230, S232, and S234).

The output controller 20C of the terminal device 12 receives the output information including the speech recognition result from the information processing device 10 via the communication unit 28 (Step S236). The output controller 20C outputs the received output information to the display unit 24A (Step S238). Subsequently, the present routine is ended.

The information processing system 1 performs the speech recognition operations which are indicated from Step S200 to Step S238 (Step S2) in each scene.

The information processing system 1 may perform speech recognition in a scene (e.g., another meeting) which is different from the scene corresponding to the language model 34C previously updated by the acquirer 30A, the registration unit 30B, the determiner 30C, and the updater 30D. In this case, the controller 30 of the information processing device 10 associates the pronunciation dictionary 34B, the language model 34C, and the recognition result DB 34D with scene identification information identifying each scene, and stores the pronunciation dictionary 34B, language model 34C, and recognition result DB 34D in the storage unit 34. The controller 30 of the information processing device 10 performs the above-described processing using the pronunciation dictionary 34B, the language model 34C, and the recognition result DB 34D corresponding to the scene identification information of the scene where the speech recognition is to be performed.

The updater 30D of the information processing device 10 performs the following processing as interrupt processing (Step S3).

Specifically, if the updater 30D determines that a predetermined condition is satisfied (Step S300), the updater 30D updates the appearance probabilities included in the language model 34C to the reference appearance probability (Steps S302 and S304). Subsequently, the present routine is ended.

As described above, the information processing device 10 according to the present embodiment includes the acquirer 30A and the registration unit 30B. The acquirer 30A acquires one or a plurality of morphemes constituting text data included in a manuscript used in a predetermined scene. The registration unit 30B converts a syllable corresponding to the morpheme into one or more phonemes, and registers the phonemes in the pronunciation dictionary 34B.

In a scene where speech recognition is performed, technical terms or coined words unique to the scene are used. It is, however, difficult for the conventional techniques to perform speech recognition on a term and a coined word that are unregistered in a dictionary. As a result, erroneous recognition may possibly occur.

By contrast, for morphemes included in the text data of the manuscript which is used in the predetermined scene such as a meeting and a lecture, the information processing device 10 according to the present embodiment registers the morphemes in the pronunciation dictionary 34B based on the manuscript.

In a scene where speech recognition is performed, if technical terms, coined words, or any other unique words are used in the scene, the information processing device 10 can register in advance the morphemes for the words, which are included in the manuscript to be used in the scene, in the pronunciation dictionary 34B. Consequently, the information processing device 10 according to the present embodiment can prevent erroneous recognition by using the pronunciation dictionary 34B updated in advance for the scene in the speech recognition.

Consequently, the information processing device 10 according to the present embodiment can increase the accuracy in speech recognition.

For each of the plurality of morphemes included in the text data, the determiner 30C determines the appearance frequency at which the morpheme appears in the text data. For each of the plurality of morphemes included in the text data and for a word string which is included in the language model 34C defining appearance probabilities of a plurality of kinds of word strings in the text, if the word string includes the morpheme used to determine the appearance frequency, the updater 30D updates the appearance probability of the word string based on the difference between the appearance frequency of the morpheme and the reference frequency.

As described above, the updater 30D updates the language model 34C based on the appearance frequencies of the morphemes in the text data, whereby the information processing device 10 can further increase the accuracy in speech recognition.

For a word string which includes a morpheme used to determine the appearance frequency, the updater 30D updates the appearance probability of the word string in the language model 34C to a value which is larger than the reference appearance probability such that the larger a difference between the reference frequency and the appearance frequency of the morpheme which is larger than the reference frequency, the larger a difference between the value and the reference appearance probability. On the other hand, for a word string which includes a morpheme used to determine the appearance frequency, the updater 30D updates the appearance probability of the word string in the language model 34C to a value which is smaller than the reference appearance probability such that the larger a difference between the reference frequency and the appearance frequency of the morpheme which is smaller than the reference frequency, the larger a difference between the value and the reference appearance probability.

As a result, in the language model 34C, the updater 30D can provide a higher appearance probability to the word string that includes a phoneme having a higher appearance frequency in the manuscript. Consequently, the updater 30D can further increase the accuracy in speech recognition.

If a predetermined condition is satisfied, the updater 30D updates the appearance probabilities included in the language model 34C to the reference appearance probability. By setting the predetermined condition to a scene change or a specific elapsed time, for example, the information processing device 10 can perform speech recognition suitable for the scenes and the time periods.

The accepter 30F accepts speech data. The divider 30G divides the speech data into one or more phonemes. The converter 30H analyzes the one or more phonemes using the pronunciation dictionary 34B and the language model 34C and converts the speech data into a character string.

The converter 30H performs speech recognition using the pronunciation dictionary 34B in which registration is done based on the text data included in the manuscript and the language model 34C which is updated based on the text data included in the manuscript, whereby the converter 30H can increase the accuracy in speech recognition.

The receiver 30E receives the speech data and the terminal identification information of the terminal device 12 that transmits the speech data. The identifier 30I identifies the operator U of the terminal device 12 as the speaker of the speech data with the terminal identification information identifying the terminal device 12. Consequently, the information processing device 10 can readily determine the speaker of the speech data in addition to providing the advantageous effects described above.

The information processing system 1 according to the present embodiment includes the information processing device 10 and the terminal device 12 that communicates with the information processing device 10. With the information processing device 10 having the configuration described above, the information processing system 1 can increase the accuracy in speech recognition.

In the present embodiment described above, the information processing device 10 performs extracting the text data included in the manuscript, extracting the morphemes from the text data, and determining the appearance frequencies of the morphemes in the text data, for example.

Alternatively, the terminal device 12 may perform at least one of extracting the text data included in the manuscript, extracting the morphemes from the text data, and determining the appearance frequencies of the morphemes in the text data. In this case, the terminal device 12 includes at least one of the acquirer 30A, the registration unit 30B, and the determiner 30C. The controller 20 of the terminal device 12, for example, further includes the acquirer 30A, the registration unit 30B, and the determiner 30C. In this case, the terminal device 12 transmits, to the information processing device 10, the text data included in the acquired manuscript, one or a plurality of morphemes included in the text data, and the appearance frequencies at which the one or the plurality of morphemes appear in the text data.

Hardware Configuration

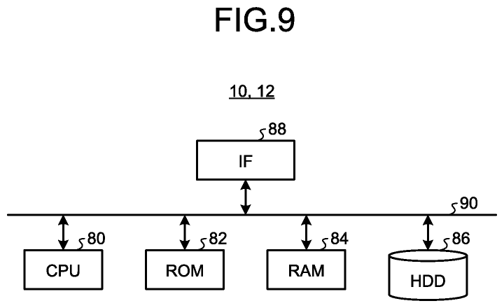

The following describes an example of the hardware configuration of the information processing device 10 and the terminal device 12 according to the present embodiment. FIG. 9 is a drawing illustrating an example of the hardware configuration of the information processing device 10 and the terminal device 12.

The information processing device 10 and the terminal device 12 are implemented by a hardware configuration using a typical computer and include a control device such as a central processing unit (CPU) 80, a storage device such as a read only memory (ROM) 82, a random access memory (RAM) 84, and a hard disk drive (HDD) 86, an interface (IF) 88 interfacing with various devices, and a bus 90 connecting the components.

In the information processing device 10 and the terminal device 12, the components described above are implemented by the CPU 80 which reads a computer program from the ROM 82 to the RAM 84 and executes the computer program.

The computer program to be executed in the information processing device 10 and the terminal device 12 to perform the above-described processing may be stored in the HDD 86. The computer program to be executed in the information processing device 10 and the terminal device 12 to perform the processing described above may be embedded and provided in the ROM 82.

The computer program to be executed by the information processing device 10 and the terminal device 12 to perform the processing described above may be stored in a computer-readable storage medium, such as a compact disc read only memory (CD-ROM), a compact disc recordable (CD-R), a memory card, a digital versatile disc (DVD), and a flexible disk (FD), as an installable or executable file, and may be provided as a computer program product. The computer program to be executed by the information processing device 10 and the terminal device 12 to perform the processing described above may be stored in a computer connected to a network, such as the Internet, and may be provided to the information processing device 10 and the terminal device 12 by being downloaded via the network. The computer program to be executed by the information processing device 10 and the terminal device 12 to perform the processing described above 12 may be provided or distributed via a network, such as the Internet.

According to the embodiments described above, the accuracy in speech recognition can be increased.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
an acquirer that acquires one or more morphemes constituting text data included in a manuscript used in a predetermined scene; and
a registration unit that converts a syllable of each of the one or more morphemes into a phoneme and registers the morpheme, the syllable, and the phoneme in a pronunciation dictionary.

2. The information processing device according to claim 1, further comprising:
a determiner that determines an appearance frequency at which each of the one or more morphemes appear in the text data; and
an updater that updates an appearance probability of a word string in a language model based on a difference between the appearance frequency of the morpheme and a reference frequency, the word string including the morpheme used to determine the appearance frequency, the language model defining the appearance probability of each of kinds of word strings in the text data.

3. The information processing device according to claim 2, wherein
the updater updates the appearance probability of the word string in the language model to a value larger than a reference appearance probability such that the larger a difference between the reference frequency and the appearance frequency of the morpheme, the larger a difference between the value and the reference appearance probability, and
the updater updates the appearance probability of the word string in the language model to a value smaller than the reference appearance probability such that the larger the difference between the reference frequency and the appearance frequency of the morpheme, the larger the difference between the value and the reference appearance probability,
wherein the word string including the morpheme which is used to determine the appearance frequency.

4. The information processing device according to claim 3, wherein the updater updates the appearance probability included in the language model to the reference appearance probability when a predetermined condition is satisfied.

5. The information processing device according to claim 2, further comprising:
an accepter that accepts speech data;
a divider that divides the speech data into one or more phonemes; and
a converter that analyzes the one or more phonemes using the pronunciation dictionary and the language model and converts the speech data into a character string.

6. The information processing device according to claim 5, further comprising:
a receiver that receives the speech data and terminal identification information of a terminal device that sends the speech data; and
an identifier that identifies an operator of the terminal device as a speaker of the speech data, wherein the terminal device is identified by the terminal identification information.

7. An information processing system comprising:
an information processing device; and
a terminal device that communicates with the information processing device,
wherein
the information processing device comprises:
an acquirer that acquires one or more morphemes constituting text data included in a manuscript created by the terminal device and used in a predetermined scene; and
a registration unit that converts a syllable of each of the one or more morphemes into a phoneme and registers the morpheme, the syllable, and the phoneme in a pronunciation dictionary.

8. A computer program product including programmed instructions embodied therein and stored on a non-transitory computer readable medium, the instructions cause a computer executing the instructions to:
acquire one or more morphemes constituting text data included in a manuscript used in a predetermined scene; and
convert a syllable of each of the one or more morpheme into a phoneme and register the morpheme, the syllable, and the phoneme in a pronunciation dictionary.
